(19) United States
(12) Patent Application Publication
(10) Pub. No.: US 2006/0121208 A1
(43) Pub. Date: Jun. 8, 2006

(54) Multiple wavelength UV curing

(76) Inventor: Stephen B. Siegel, Chicago, IL (US)

Correspondence Address: WELSH & KATZ, LTD, 120 S RIVERSIDE PLAZA, 22ND FLOOR, CHICAGO, IL, 60606, US

(21) Appl. No.: 10/386,980

(22) Filed: Mar. 12, 2003

Related U.S. Application Data
(63) Continuation-in-part of application No. 10/339,264, filed on Jan. 9, 2003.

(51) Int. Cl. C08F 2/46

(52) U.S. Cl. 427/487

(57) ABSTRACT

A UV curing apparatus and method is provided for enhancing UV curing of inks, coatings and adhesives having UV photo initiators therein by subjecting the UV curable inks, coatings or adhesives to UV light at different wavelengths. Preferably, the UV LED assemblies are alternated in rows such that a 390 nm emitting UV LED is positioned first followed by a 370 nm emitting UV LED followed by a 415 nm emitting UV LED and this arrangement is then repeated through the row or one row can have only 390 nm emitting UV LEDs, the next row having only 370 nm emitting UV LEDs and the next row having only 415 nm emitting UV LEDs.

### CROSS REFERENCE TO RELATED APPLICATIONS

This application is a continuation-in-part of U.S. application Ser. No. 10/339,264 filed Jan. 9, 2003.

### BACKGROUND OF THE INVENTION

1. Field of the Invention

The present invention relates to a method and apparatus for utilizing ultraviolet (UV) light at different wavelength emissions, and arranged in a random, mixed or sequential arrangement to cure UV curable inks, coatings or adhesives of varying thickness and/or having selected pigments and additives therein. The inks, coatings or adhesives have UV photo initiators which, when exposed to UV light, convert monomers in the inks, coatings or adhesives to linking polymers to solidify the monomer material.

2. Description of the Prior Art

Heretofore, UV-LED arrays have been proposed for curing inks, coatings or adhesives as disclosed in U.S. application Ser. No. 10/339,264, the disclosure of which is incorporated herein by reference. The prior application teaches one to stagger rows of UV-LED's in different arrays on a panel positioned closely adjacent a product to be cured, to move the product past the array, to move the array in a generally orbital path to uniformly apply UV light on the product and to inject an inert, heavier than air or lighter than air gas in the area between the panel and the product.

However different wavelengths of UV light are better suited for different thicknesses of ink, coating or adhesive and/or for different components in the ink coating or adhesive.

For example, thick polymers require longer wavelengths for curing. Surface curing requires shorter wavelengths.

In addition pigmented coatings are better cured with wavelengths dissimilar to the absorption wavelength of the pigments. This is also true for the wavelength absorption characteristics of resins and additives in an ink, coating or adhesive.

It is, therefore, desirable to provide an improved UV method and apparatus for applying UV light at different wavelengths to a UV curable product to more effectively cure UV inks, coatings and adhesives in or on the product.

### BRIEF SUMMARY OF THE INVENTION

As will be described in greater detail hereinafter, the method and device or apparatus of the present invention provide techniques and structures for applying UV light emitted from UV-LED's having different wavelength emissions so that such light is more effective in curing inks, coatings and adhesives.

According to the present invention there is provided a random, mixed or sequential array of UV LED's having different wavelength emissions for emitting UV light of different wavelengths onto a UV curable ink, coating or adhesive.

The UV-LED's can include LED's that emit three different wavelengths, namely, 415 nm, 390 nm and 370 nm. These LED's can be placed in a row and arranged alternatively, 390 nm, 415 nm and then 370 nm, and continuously repeated in this pattern or order in the row, e.g., 390 nm, 415 nm, 370 nm, etc. The order also can be changed, e.g., 370 nm, 390 nm, and 415 nm.

Another variation can be to provide a full row of LED's that emit light at 415 nm, then a full row of LED's that emit light at 90 nm, and then a full row of LED's that emit light at 370 nm.

As other UV wavelength emitting diodes become available, e.g., 350 nm, they may also find use in the arrays of the present invention

Further, to achieve the greatest variation of wavelengths, an array can be placed next to another source of light, such as a fluorescent lamp whose phosphors were chosen to augment the increase of light wavelengths. For example, OSRAM SYLVANIA, INC. of Danvers Mass. offers a type 2011C fluorescent lamp that emits 51 nm, a type 2052 that emits 371 nm, a type 2092 that emit 433 nm, and a type 2162 that emits 420 nm.

Also the UV-LED's in one row can be staggered relative to UV LED's in adjacent rows.

### BRIEF DESCRIPTION OF THE DRAWINGS

FIG. 1 is a top plan elevational view of a prior art UV LED assembly including a pad for a cathode and an anode mounting an UV LED chip in accordance with the teachings of the present invention;

FIG. 2 is a top plan elevational view of a design of mating building blocks or substrates which can be blank or have an anode and cathode mounted thereon in accordance with the teachings of the present invention;

FIG. 3 is a front elevational view of one array of UV LED assemblies wherein rows of UV LED assemblies are arranged in the array with alternate rows of UV LED assemblies in one row being staggered from the UV LED assemblies in the adjacent rows in accordance with the teachings of the present invention;

FIG. 4 is front elevational view of a panel of six arrays of UV LED assemblies shown in FIG. 3 in accordance with the teachings of the present invention and shows schematically a first eccentric cam which moves against one side edge of the panel against a spring at the opposite side edge of the panel so as to move, reciprocate or translate the panel in an X direction and a second eccentric cam which acts against an upper edge of the panel and against a spring bearing against a lower edge of the panel to cause movement of the panel in the Y direction and thereby cause all the arrays to move in a orbital, circular, or elliptical path when the first and second cams are rotated about their axes;

FIG. 5 is a block schematic diagram of a web made of, or carrying products, articles or other objects to be UV cured trained over rollers to move in a generally vertical path past the panel of arrays of UV LED assemblies shown in FIG. 4 such that the products, articles or other objects with UV photo initiators therein can be cured as each product, article or other object moves past the arrays of UV LED assemblies while a non-oxygen, heavier than air gas is injected from a gas tube located near the top of the path of movement of the web; and

FIG. 6 is a block schematic view of a web made of, or carrying, products, articles or other objects to be UV cured trained over rollers to move in a generally vertical path past the panel of arrays of UV LED assemblies shown in FIG. 4 such that each product, article or other object with UV photo initiators therein can be cured as each product, article or other object moves past the arrays of UV LED assemblies while a non-oxygen gas is injected from a gas tube located near the bottom of the path of movement of the web.

FIG. 7 is a plan view of another way of positioning UV LED assemblies in at least three rows where the spacing between UV LED assemblies in each row is increased to establish a three tier staggering of UV LED assemblies.

FIG. 8 is a plan view of a staggered array of UV LED assemblies which emit UV light at different wavelengths.

FIG. 9 is a plan view of one die array of four rows of LED chips.

FIG. 10 is an enlarged view of a portion of the array shown in FIG. 9.

FIG. 11 is an arrangement of four of the arrays shown in FIG. 9 in a line and two long fluorescent lamps positioned beside the line of arrays.

### DETAILED DESCRIPTION OF THE INVENTION

A detailed description of the preferred embodiments and best modes for practicing the invention are described herein.

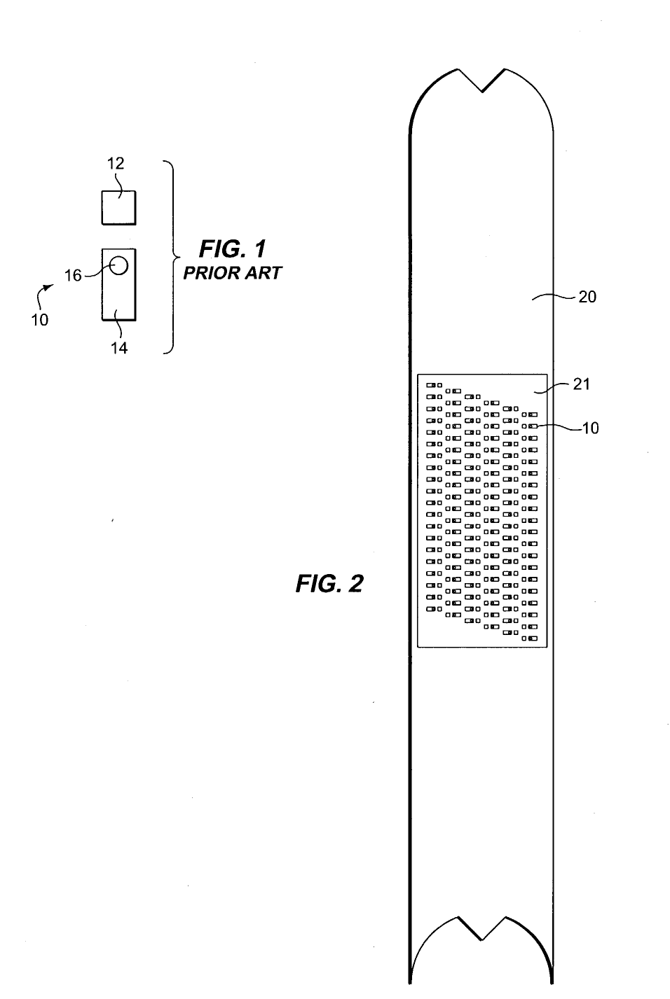

Referring now to the drawings in greater detail, there is illustrated in FIG. 1 a prior art ultraviolet light-emitting diode (UV LED) assembly 10 including a cathode pad 12 and an anode 14 mounting a chip 16, which comprises a UV LED chip 16.

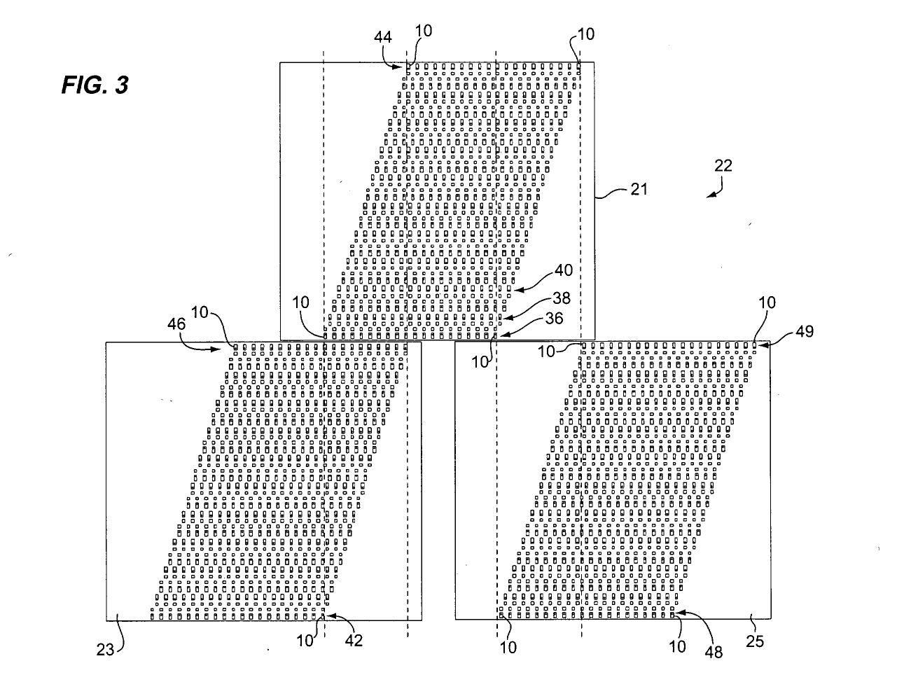

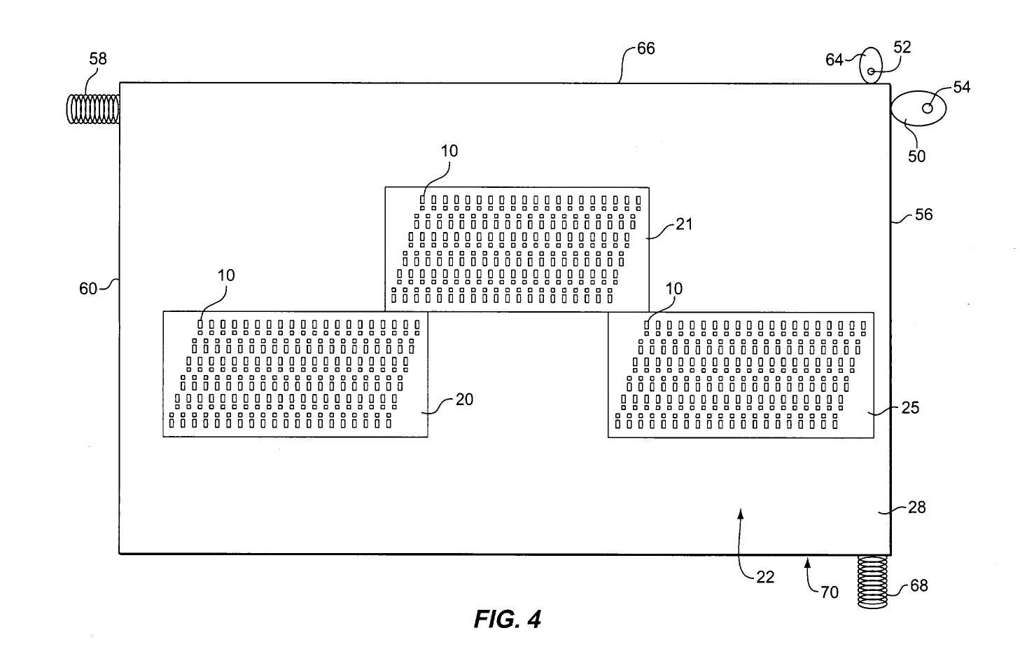

Each cathode pad 12 (FIG. 1) is connected to a wire conductor, as is each anode 14. Referring now to FIG. 2, there is illustrated therein a building block 20 having a first array 21 of the UV LED assemblies 10 thereon, namely, pads 12 and anodes 14, which provide a plurality of UV LED chips 16. The building block 20 is designed to mate with similar building blocks to form a group 22 of arrays 21, 23 and 25 as shown in FIGS. 3 and 4. In this way, several of the blocks 20 can matingly engage each other and be arranged in a pattern (e.g., like tiles on a floor) on a panel 28 (FIG. 4).

As shown in FIG. 3, the UV LED assemblies 10 in each array 21, 23 and 25 are spaced apart in a first lower row 36 of UV LED assemblies 10. Then, in a second adjacent row 38, the UV LED assemblies 10 are arranged in a staggered manner so that they are located above the spaces between the UV LED assemblies 10 in the first row. In the same manner, the next upper row 40 of UV LED assemblies 10 is staggered and a total of twenty (20) staggered rows are provided in the UV LED array 21 shown in FIG. 3.

Also, as shown in FIG. 3 the beginning of the first UV LED assembly 10 in the lowest row 36 in the first array 21 is aligned with the end of the last UV LED assembly 10 at the end of the lowest row 42 in the second, lower left, array 23.

Then, the beginning of the first UV LED assembly 10 in the uppermost row 44 in the first array 21 is aligned with the end of the last UV LED assembly 10 in the uppermost row 46 in the second, lower left array 23. Next, the end of the last UV LED assembly 10 in the lowest row 36 in the first array 21 is aligned with the beginning of the first UV LED assembly 10 in the lowest row 48 in the third, lower right array 25. Finally, the end of the last UV LED assembly 10 in the uppermost row 44 in the first array 21 is aligned with the beginning of the first UV LED assembly 10 in the uppermost row 49 in the third, lower right array 25, as shown in FIG. 3.

As shown best in FIG. 4, the three arrays 21, 23 and 25 can be arranged on the panel 28 in a staggered manner so that the UV light from each UV LED assembly 10 is not only spaced and staggered relative to adjacent rows in the array but also spaced and staggered relative to the rows in the other arrays. Also more than three arrays 21, 23 and 25 can be provided, such as six arrays, not shown.

Also shown in FIG. 4, are mechanisms, preferably cams 50 and 64, that can be provided for moving, translating or reciprocating the panel 28 back and forth in the X direction and up and down in the Y direction, much like in an orbital sander. The first, x axis, cam 50 is eccentrically mounted for rotation about a shaft 54 to act against one side edge 56 of the panel 28 with a spring 58, such as a helical tension spring, positioned to act against the other side edge 60 of the panel 28. The center of cam 50 is spaced apart and offset and not coaxial nor concentric nor aligned with the center of the shaft 54.

Then the second, y axis, cam 64 (FIG. 4) is eccentrically mounted for rotation on a shaft 52 to act against an upper edge 66 of the panel 28 against the action of a spring 68, such as a helical tension spring, positioned to act against a lower edge 70 of the panel 28. The center of cam 64 is spaced apart and offset and not coaxial nor concentric nor aligned with the center of shaft 52.

Rotation of the shafts 52 and 54 (FIG. 4) each by a prime mover such as a variable speed motor (not shown) can cause the panel 28 to move in a generally orbital, annular, circular, or elliptical path of movement. This will result in orbital movement of each UV LED assembly 10 in each of the rows in each of the arrays 21, 23 and 25 mounted on the panel 28 so as to spread out the emitted UV light and uniformly apply the UV light to the products, articles or other objects to be UV cured. This spreading of the UV light also minimizes, if not altogether eliminates the creation of, so called “hot spots” of UV light.

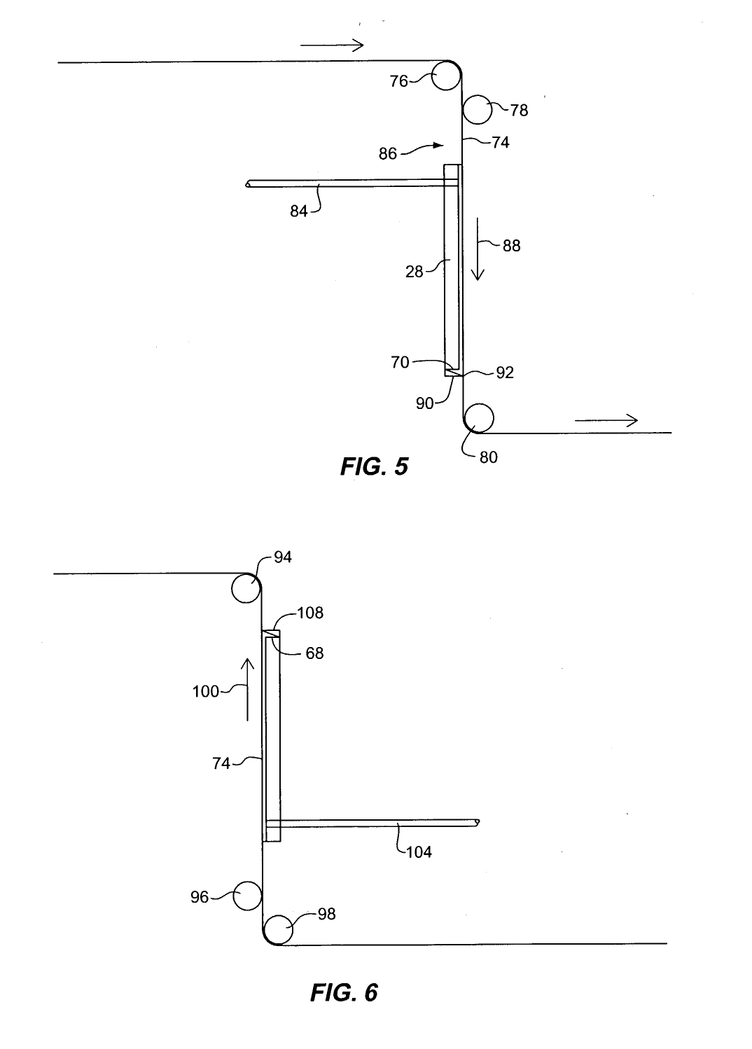

As shown in FIG. 5, where a schematic block diagram of one UV curing apparatus, assembly, mechanism or device constructed according to the teachings of the present invention is shown, the panel 28 of UV LED arrays 21, 23 and 25 is positioned generally vertically and closely adjacent the path of movement of a conveyor belt comprising web 74 which is trained over rollers 76, 78 and 80 to move generally upright and vertically past and closely adjacent and in proximity to the panel of UV LED arrays 21, 23 and 25. For this purpose, at least one of the rollers 76, 78 and/or 80 of a conveyor can be a drive roller.

UV curable products, articles or other objects, such as labels, positioned in or on the web 74 (FIG. 5), can have one or more UV curable inks, coatings and/or adhesives between a plastic cover layer and the label. The UV curable ink, coating, and/or adhesive can have UV photo initiators therein which will polymerize the monomers in the UV curable ink, coating, or adhesive when subjected to UV light within a predetermined UV wavelength range.

The UV curable ink, coating and/or adhesive preferably is located on the side of the web 74 (FIG. 5) that is closest to and faces the panel 28. Preferably, the spacing between the UV LED assemblies and the ink, coating or adhesive is between 0.001 inch and 0.3 inch to enhance the effectiveness of the UV emitted light which dissipates exponentially as the distance to the product, article or other UV curable object to be treated increases.

Preferably, the shafts 52 and 54 (FIG. 4) are rotated to cause orbital movement of the panel 28 and UV LED assemblies as the web 74 containing the product, article or other UV curable object moves past the panel 28. Such movement also minimizes “hot spots” and provide uniform sweeping, distribution, and application of the UV light from the UV LED assemblies 10.

The block schematic diagram of the assembly or device, shown in FIG. 5 is provided to minimize exposure of the products, articles or other objects during curing to oxygen, which inhibits UV curing. A gas tube 84 providing an upper gas injection is provided on the assembly and device for injecting a heavier-than-air, gas, e.g., carbon dioxide, near an upper end 86 of a path of downward movement, indicated by the arrow 88, of the web 74, so that the gas can flow downwardly in the space between the panel 28 and the web 74 to provide an anaerobic area between the UV LED assemblies 10 on the panel 28 and the web 74 having UV curable products, articles or other objects to be cured.

A wiper blade 90 (FIG. 5) providing a lower inhibitor go can be positioned adjacent the lower edge 70 of the panel 28 for holding, compressing, collecting and/or blanketing the gas in the area between the orbiting UV LED arrays 21, 23 and 25 (FIG. 4) and the moving web 74 (FIG. 5). Preferably the wiper blade 90 is fixed to the lower edge 70 of the panel 28 and has an outer edge 92 that is positioned to wipe against the moving web 74. In this way, the injected gas can be inhibited from escaping the curing area.

FIG. 6 is a block schematic diagram of a UV curing apparatus, assembly, mechanism or device constructed according to the teachings of the present invention where the moving web 74 is trained about rollers 94, 96 and 98, at least one of which can be a drive roller, to cause the web 74 with the UV curable products, articles or other objects thereon or therein to move upwardly, as shown by the arrow 100, past the panel 28 mounting arrays 21, 23 and 25 (FIG. 4) of UV LED assemblies, much the same as in the UV curing apparatus, assembly and device shown in FIG. 5.

In the apparatus, assembly or device shown in FIG. 6, a gas tube 104 providing a lower gas injector is positioned near a lower end 106 of the path 100 of movement of the web 74 for injecting an inert lighter-than-air, non-oxygen-containing gas, e.g., helium, in the area between the orbiting panel 28 (FIG. 4) and the upwardly moving web 74 (FIG. 6) thereby provide an anaerobic area to enhance and facilitate curing of the UV photo initiators in the UV curable products, articles or other objects that are carried by the web 74.

A wiper blade 108 (FIG. 6) providing an upper inhibitor 108 is positioned near the upper edge 68 of the panel 28 as shown in FIG. 6 to minimize the escape of the lighter-than-air gas and hold, compress, collect and/or blanket the injected gas in the curing area between the orbiting panel 28 (FIG. 4) and the moving web 74 (FIG. 6), much the same as in the UV curing apparatus, assembly and device shown in FIG. 5. Again, the wiper blade 108 (FIG. 6) can be fixed to the upper edge 68 and arranged to wipe against the web 74.

To avoid overheating the UV LED assemblies 10, i.e., to control the heat generated by the UV LED assemblies 10, the power supplied to the UV LED assemblies can be periodically or sequentially activated and deactivated, i.e. can be turned on and off, at a relatively high frequency. Also, the duty cycle of the on-off cycle can be varied to adjust the UV light intensity.

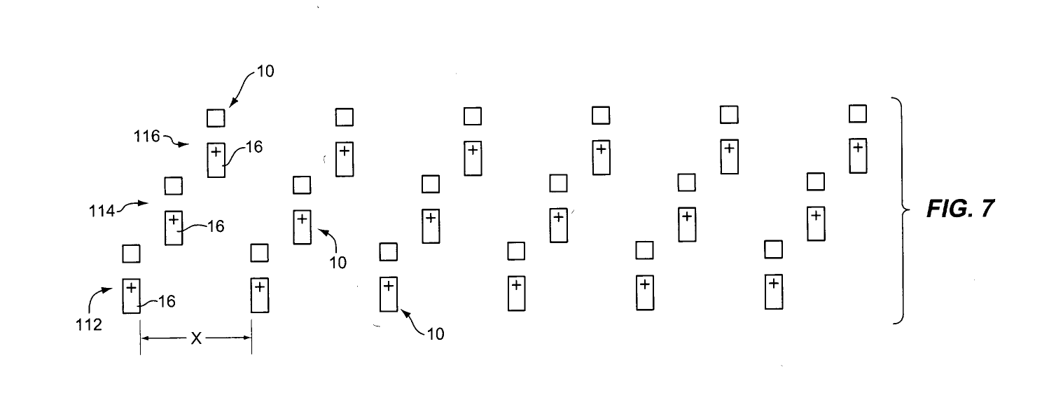

In FIG. 7 is illustrated another way to position the UV LED assemblies, namely, the LED chips 16, and achieve the same uniformity as shown in FIG. 2. This would be to use 3 rows to achieve the uniformity. That is, to have the LED chips 16 in a first row 112 arranged at a distance of X, and to have the next row 114 (row 2) start at a distance ⅓ in from the start of the first row 112 and the next row 116 (row 3) start at a distance ⅔ in from the start of the first row 112 or at a distance ⅓ in from the start of the second row 114.

It will be understood that the space X can be equal to the width of 1, 2, 3, 4, 5, etc. of an UV LED assembly 10 to provide a desired staggering of the light beams from the UV LED assemblies 10.

Also, in situations where UV curable ink or adhesive might splatter on the UV LED assemblies 10, a clear/transparent sheet or layer of plastic material can be placed over the arrays 21, 23 and 25 to protect the UV LED assemblies 10. Then, the sheet or layer is cleaned or replaced periodically.

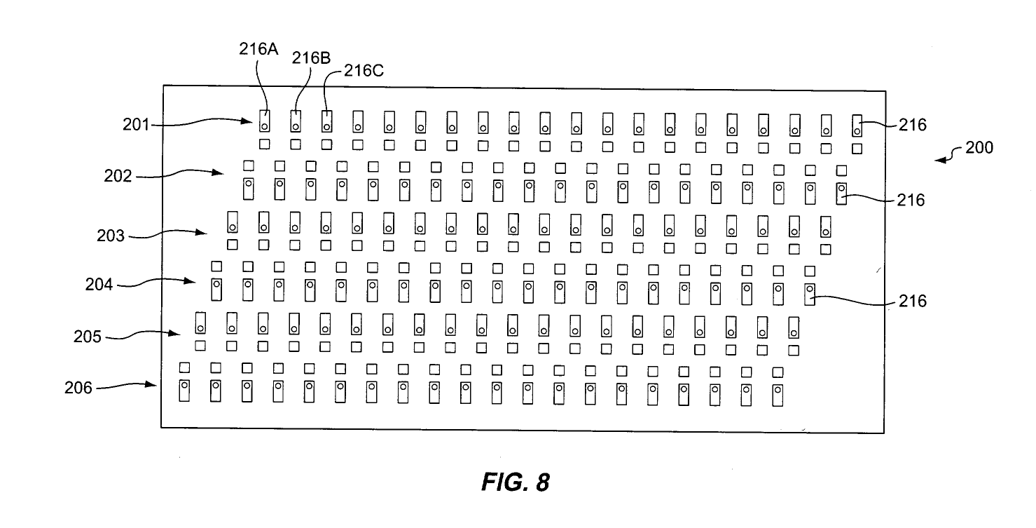

In the array 200 shown in FIG. 8, there are illustrated six (6) staggered rows 201-206 of UV LED assemblies 216. This array 200 is similar to the array shown in FIG. 2. However, the individual UV LED assemblies 216 in the array have different wavelengths for applying UV light having different wavelength emissions which is more effective in curing inks, coatings and adhesives having UV photo initiators therein and having a varying thickness.

It is to be understood that UV light emitted from an LED or from a fluorescent lamp is over a range of wavelengths, often referred as the Spectral Energy Distribution with a peak at one wavelength which is the identified wavelength, e.g. 370 nm.

The UV LED assemblies can be positioned in a random, mixed manner or in sequential rows.

For example, in row 201 the first UV-LED assembly 216A can emit light at 390 nm, the next UV LED assembly 216B can emit UV light at 370 nm and the following UV LED assembly 216C can emit UV light at 415 nm, and so on, repeating this pattern throughout the row.

The next row 202, and subsequent rows 203-206, can have the same pattern or a different pattern.

Alternatively, all the UV LED assemblies 216 in row 201 can emit light at 390 nm, all the UV LED assemblies 216 in row 202 can emit light at 370 nm and all the UV LED assemblies 216 in row 203 can emit light at 415 nm and this pattern can be repeated for the remaining rows 204-206. The pattern or order also can be changed, e.g., 370 nm, 390 nm, and 415 nm.

Another variation would be a random mixture of UV LED assemblies which emit light at 415 nm, 390 nm and 370 nm or other wavelengths as such UV wavelength emitting diodes become available, e.g., 350 nm, 400 nm and 420 nm.

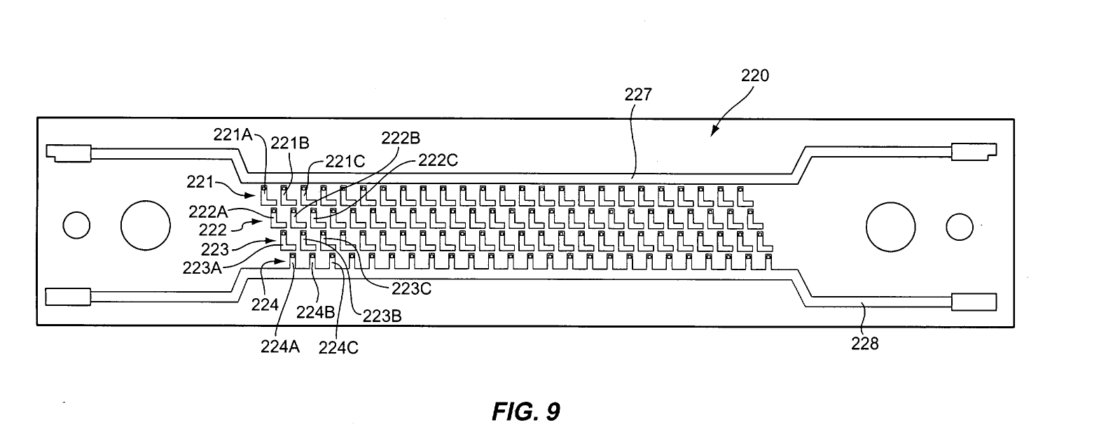

In FIG. 9 is illustrated a lamp panel array 220 of four rows 221-224 of UV LED assemblies 226. Typically the panel array 220 is about four inches long and has two bus strips 227 and 228.

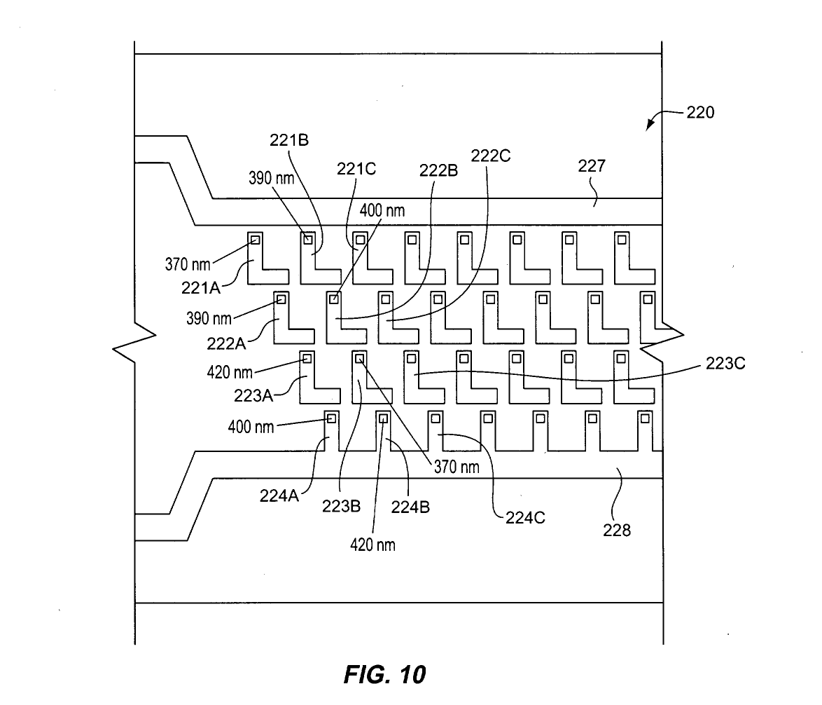

As shown in FIG. 10 the first UV LED assembly 221A in the first row 221 can emit light at 370 nm, the first UV LED assembly 222A in the second row 222 can emit light at 390 nm, the first UV LED assembly 223A in the third row 223 can emit light at 420 nm, and the first UV LED assembly 224A in the fourth row 221 can emit light at 400 nm.

Then the second UV LED assembly 221B in the first row 221 can emit light at 390 nm, the second UV LED assembly 222B in the second row 222 can emit light at 400 nm, the second UV LED assembly 223B in the third row 223 can emit light at 370 nm, and the second UV LED assembly 224B in the fourth row 224 can emit light at 420 nm.

The third UV LED assembly 221C, 222C, 223C and 224C in each row 221-224 can then emit light at, respectively, 420 nm, 390 nm, 400 nm and 370 nm. It will be understood that the UV LED's emit UV light in a spectral range and the predominant wavelength in the spectral range is the wavelength identified.

Further, to achieve the greatest variation of wavelengths, the panel array 220 can be arranged next to another source of light, such as a fluorescent lamp (or lamps) whose phosphors are chosen to augment the increase of light wavelengths. For example, the OSRAM SYLVANIA, INC. Division of OSRAM GmbH of Danvers Mass. offers a phosphor type 2011C fluorescent lamp that emits 351 nm, a phosphor type 2052 lamp that emits 371 nm, a phosphor type 2092 lamp that emits 433 nm, and a phosphor type 2162 lamp that emits 420 nm.

Theses are several examples of wavelengths that could easily be added to a curing mix.

Additionally, a germicidal lamp or a Pen Ray lamp can be used for the addition of 254 nm.

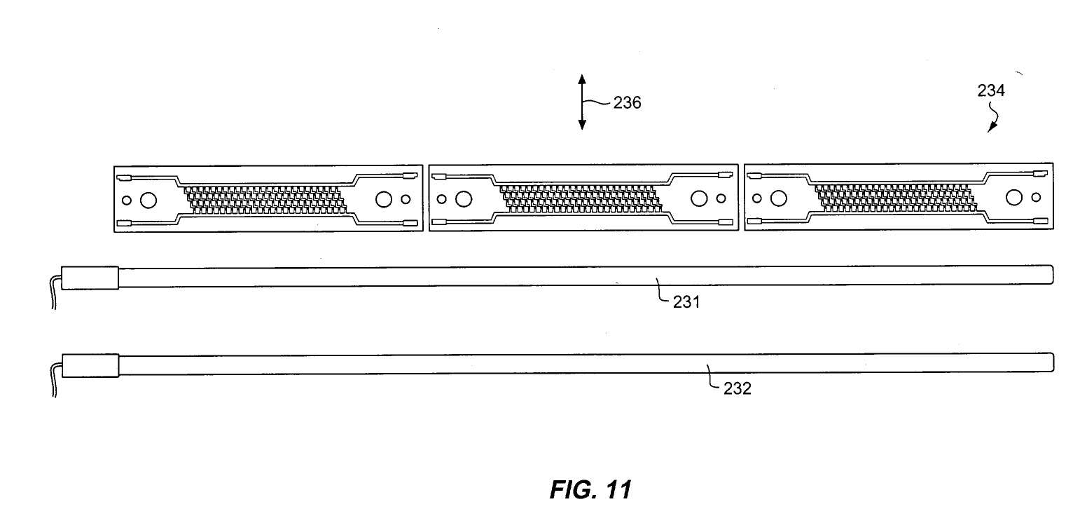

In FIG. 11 are illustrated two fluorescent lamps 231 and 232 which can be positioned adjacent an elongate panel 234 formed by three panel arrays 220 arranged end-to-end and electrically connected (soldered) together. A web, similar to the web 74, and carrying a UV curable product can be arranged to move across the elongate panel 234 as indicated by the arrow 236 as shown.

It will be understood that a number of panel arrays 220, e.g., three (3) eight (8) can be arranged end to end to form a UV light emitting area and that more than one or two fluorescent lamps can be used with the light emitting area.

Of course, the panel 234 will be oscillated, such as with cams (see FIG. 4), with a significant sweep to ensure overlapping of the four different wavelengths.

The UV curable product will also traverse the two fluorescent lamps 231 and 232 and any additional light sources employed.

Also, as provided in the structures shown in FIGS. 5 and 6 and described above, an inert gas can be injected into the space between the panel 234 and the moving web having a UV curable product therein or thereon.

Empirical tests show that LED chips with a larger area emit higher intensity UV light. This feature can be important where the space between the panel 234 and the web is a factor in the curing. In this respect a 1 mm area LED chip emits 10 times the light of a 0.346 mm area LED chip and the light strength decreases by the square of the space or distance between the lamp and the UV curable product. The larger chips are referred to as “flip” chips.

From the foregoing description it will be apparent that the method and device or apparatus of the present invention have a number of advantages, some of which have been described above and others of which are inherent in the invention and examples.

Although embodiments of the invention have been shown and described, it will be understood that various modifications and substitutions, as well as rearrangements of components, parts, equipment, apparatus, process (method) steps, and uses thereof, can be made by those skilled in the art without departing from the teachings of the invention. Accordingly, the scope of the invention is only to be limited as necessitated by the accompanying claims and examples.

1. A method for applying ultraviolet (UV) light to UV photo initiators in UV curable inks, coatings or adhesives in products, articles or other solid objects, comprising the steps of:
staggering rows of UV light-emitting diode (LED) assemblies, comprising UV LED chips on a panel so that the UV LED chips of the UV LED assemblies of a first row are offset from the UV LED chips of the UV LED assemblies of a second row;
emitting a first wavelength of UV light from the first row of UV LED assemblies, said first wavelength of UV light being selected from the group consisting of 350 nm, 370 nm, 390 nm, 400 nm, 415 nm, and 420 nm;
emitting a second wavelength of UV light from the second row of UV LED assemblies, said second wavelength of UV light being a different wavelength than the first wavelength of UV LED light, said second wavelength of UV light being selected from the group consisting of 350 nm, 370 nm, 390 nm, 400 nm, 415 nm, and 420 nm;
said different wavelengths of UV light being emitted at the same intensity; and
uniformly applying the first and second wavelength of UV light at the same intensity entirely over the UV inks, coatings or adhesives in the products, articles or other solid objects by moving the panel relative to the UV curable inks, coatings or adhesives in the products, articles or other solid objects at the same intensity entirely over to uniformly distribute the UV light at said different wavelengths at the same intensity entirely over the UV curable inks, coatings or adhesives in the products, articles or other solid objects in the absence of masks, forming a masking pattern, spacer pattern or for use as printed electric circuits for printed wiring boards, dental material, water purification, and insect lights, to identically cure and produce similarly polymerized UV cured inks, coatings or adhesives in the products, articles or other solid objects.

2-3. (canceled)

4. The method of claim 1 wherein said panel of staggered rows of UV LED assemblies is moved in an oscillatory path over the UV curable inks, coatings or adhesives in the products, articles or other solid objects.

5. The method of claim 1 including the step of positioning at least one fluorescent lamp adjacent the panel to emit a fluorescent wavelength of light onto the UV curable inks, coatings or adhesives in the products, articles or other solid objects, said fluorescent wavelength of light being different than said first and second wavelengths, and said fluorescent wavelength being selected from the group consisting of 51 nm, 371 nm, 433 nm, and 420 nm.

6. The method of claim 1 including the step of injecting an inert gas in a space between the panel and the UV curable inks, coatings or adhesives in the products, articles or other solid objects.

7-15. (canceled)

16. The method of claim 1 including moving the panel of staggered rows of UV LED assemblies in an elliptical path.

17. The method of claim 1 wherein said panel of staggered rows of UV LED assemblies is moved in an orbital path across the UV curable inks, coatings or adhesives in the products, articles or other solid objects.

18. The method of claim 1 wherein the panel of staggered rows of UV LED assemblies is moved in an annular or circular path over the UV curable inks, coatings or adhesives in the products, articles or other solid objects.

19-20. (canceled)

21. An apparatus for applying ultraviolet (UV) light to UV photo initiators in UV curable inks, coatings or adhesives in the products, articles or other solid objects, comprising:
at least one panel comprising an array with staggered rows of UV light-emitting diode (LED) assemblies, each of the rows comprising UV light-emitting diodes (LEDs), said rows including at least a first row and a second row, said UV LEDs of said first row being offset from all the UV LEDs in the second row;
said first row of UV LEDs emitting a first wavelength of UV light selected from the group consisting of 350 nm, 370 nm, 390 nm, 400 nm, and 420 nm;
said second row of UV LEDs emitting a second wavelength of UV light, said second wavelength being a different wavelength than the first wavelength, said second wavelength being selected from the group consisting of 350 nm, 370 nm, 390 nm, 400 nm, and 420 nm;
a panel-rotating mechanism for rotating and moving the panel of staggered rows of UV LEDs about the UV curable inks, coatings or adhesives in the products, articles or other solid objects to uniformly apply and distribute the UV light at different wavelengths on the UV curable inks, coatings or adhesives in the products, articles or other solid objects in the presence of masks, forming a masking pattern, spacer pattern, or for use as printed electric circuits for printed wiring boards, dental material, water purification, and insect lights, to identically cure and produce similarly polymerized UV cured inks, coatings or adhesives in the products, articles or other solid objects.

22. The apparatus of claim 21 wherein the panel-rotating mechanism comprises a cam for engaging the panel, a shaft connected to the cam, and a variable speed motor for driving and rotating said shaft and cam.

23. (canceled)

24. The apparatus of claim 21 wherein said panel-rotating mechanism comprises means for moving said panel in an oscillatory, orbital, annular, circular, or elliptical path.

25. The apparatus of claim 21 including at least one fluorescent lamp mounted adjacent the panel.

26. The apparatus of claim 21 including an inert gas disposed in a space between the panel and the UV curable inks, coatings or adhesives in the products, articles or other solid objects.

27-33. (canceled)

34. The apparatus of claim 21 including 3 to 8 of said panels arranged end-to-end and electronically connected together to form a UV light emitting area.

35. (canceled)
